(19) United States
(12) Patent Application Publication
(10) Pub. No.: US 2022/0223039 A1
(43) Pub. Date: Jul. 14, 2022

(54) MONITORING CENTER, MONITORING SYSTEM AND METHOD

(71) Applicant: DENSO CORPORATION, Kariya-city, Aichi-pref. (JP)

(72) Inventor: Toru NAGURA, Kariya-city (JP)

(21) Appl. No.: 17/657,074

(22) Filed: Mar. 29, 2022

Related U.S. Application Data
(63) Continuation of application No. PCT/JP2020/028384, filed on Jul. 22, 2020.

(30) Foreign Application Priority Data
Sep. 30, 2019 (JP) 2019-178837

(51) Int. Cl. G08G 1/0967; G07C 5/00; B60W 60/00; G05B 13/02

(52) U.S. Cl. CPC G08G 1/096725; G07C 5/008; B60W 2554/406; G05B 13/0265; B60W 2556/45; B60W 60/0015

(57) ABSTRACT

A monitoring center communicates with an autonomous vehicle via a network to monitor the autonomous vehicle. The monitoring center includes a communication unit that receives data regarding a vehicle state from the autonomous vehicle, a determination unit determines whether a state of the autonomous vehicle satisfies a condition for assistance by an operator based on the data regarding a vehicle state, and an operator cooperation unit that notifies the operator of an assistance request if it is determined that the condition is satisfied. The determination unit performs the determination based on a condition different from the last condition if a situation in which the autonomous vehicle is placed is not changed from when an assistance request is issued last time.

### CROSS-REFERENCE TO RELATED APPLICATION

The present application is based on and claims the benefit of priority from earlier Japanese Patent Application No. 2019-178837 filed on Sep. 30, 2019, the description of which is incorporated herein by reference.

### BACKGROUND

### Technical Field

The present disclosure relates to a monitoring center for autonomous vehicles and a monitoring system including the same.

### Related Art

There have been known remote monitoring techniques for ensuring safety of autonomous vehicles during autonomous traveling.

### SUMMARY

An aspect of the present disclosure provides a monitoring center that communicates with an autonomous vehicle via a network to monitor the autonomous vehicle. The monitoring center includes: a communication unit that receives data regarding a vehicle state from the autonomous vehicle; a determination unit determines whether a state of the autonomous vehicle satisfies a condition for assistance by an operator based on the data regarding a vehicle state; and an operator cooperation unit that notifies the operator of an assistance request if it is determined that the condition is satisfied. The determination unit performs the determination based on a condition different from the last condition if a situation in which the autonomous vehicle is placed is not changed from when an assistance request is issued last time.

### BRIEF DESCRIPTION OF THE DRAWINGS

In the accompanying drawings:

FIG. 1 is a diagram illustrating a configuration of a monitoring system of a first embodiment;

FIG. 2A is a diagram illustrating an example of conditions for assistance stored in an applicable condition storage unit;

FIG. 2B is a diagram illustrating an example of conditions for assistance stored in a condition table;

FIG. 3 is a diagram illustrating operation of a monitoring center of the first embodiment;

FIG. 4 is a diagram illustrating a configuration of a monitoring system of a second embodiment;

FIG. 5 is a diagram illustrating operation of a monitoring center of the second embodiment;

FIG. 6 is a diagram for describing an example of a condition input by an operator; and

FIG. 7 is a diagram illustrating a configuration of a monitoring system of a third embodiment.

### DETAILED DESCRIPTION OF THE PREFERRED EMBODIMENTS

There have been known remote monitoring techniques for ensuring safety of autonomous vehicles during autonomous traveling. In JP 2019-87015 A, an autonomous vehicle automatically stops upon detection of an obstacle based on information acquired from an autonomous sensor including a camera, and transmits an image of the surroundings of the vehicle captured by the camera to a remote monitoring center. When the autonomous vehicle automatically stops, the remote monitoring center determines, based on the received image captured by the camera, whether it should resume traveling of the autonomous vehicle. In this configuration, an observer (operator) in the remote monitoring center supplements the detection performance of the sensor of the autonomous vehicle to ensure safety in autonomous traveling of the vehicle.

According to the invention disclosed in JP 2019-87015 A, the operator is called every time the autonomous vehicle makes a stop. As a consequence, a monitoring task is given to the operator regardless of whether remote operation is actually necessary. In addition, after the operator is called once and determines whether it is necessary to provide assistance, if the situation is not improved, the operator is likely to be called a number of times. This causes a problem that load is applied on the operator and a labor cost for the operator increases.

In view of the above circumstances, the present disclosure aims to provide a monitoring system capable of reducing load on an operator.

With reference to the drawings, a monitoring system of an embodiment of the present disclosure will be described.

### First Embodiment

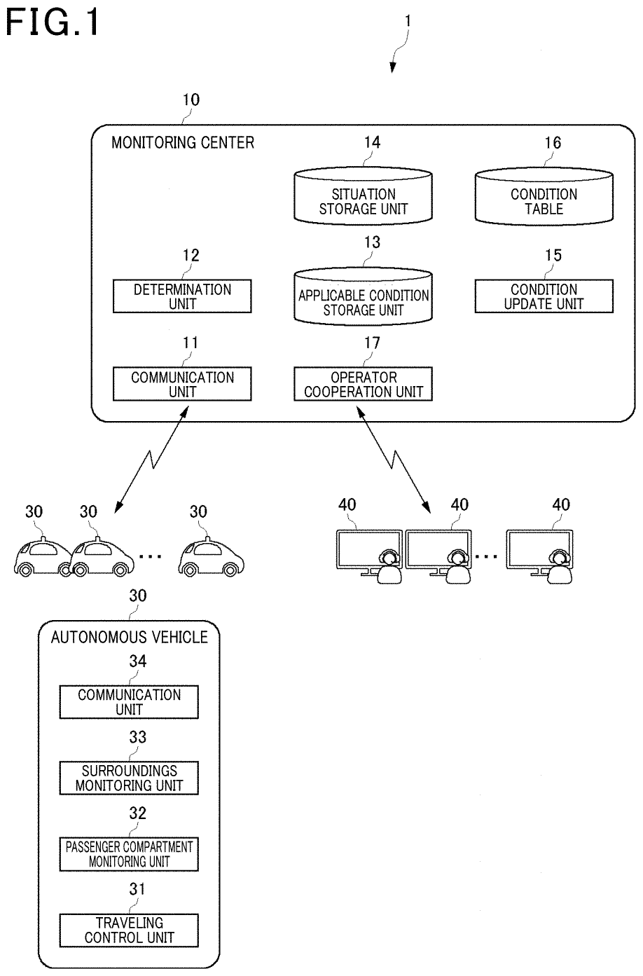

FIG. 1 is a diagram showing a configuration of a monitoring system 1 of a first embodiment. The monitoring system 1 includes a monitoring center 10 and autonomous vehicles 30. The monitoring center 10 monitors the autonomous vehicles 30. The autonomous vehicles 30 are configured to communicate with the monitoring center 10 via a network. The autonomous vehicles 30 are monitored by the monitoring center 10.

### [Monitoring Center]

The monitoring center 10 is connected to operator terminals 40 that are operated by operators. When an autonomous vehicle 30 requires assistance, the monitoring center 10 transmits data concerning the autonomous vehicle 30 to the operator terminal 40 to cooperate with the operator.

The monitoring center 10 includes a communication unit 11, a determination unit 12, an applicable condition storage unit 13, a situation storage unit 14, a condition update unit 15, a condition table 16, and an operator cooperation unit 17.

The communication unit 11 has a function of communicating with the autonomous vehicles 30. The communication unit 10 receives data (vehicle state data) from the autonomous vehicle 30 regarding vehicle states of the autonomous vehicle 30. The vehicle state data includes data regarding traveling states of the vehicle (e.g., acceleration, speed and traveling direction), a current position, operation states of on-vehicle devices (e.g., blinkers, wipers, light, brake and accelerator) and the like.

The communication unit 11 may receive, in addition to the vehicle state data, data concerning the surrounding environment (surrounding environment data) from the autonomous vehicles 30. The data concerning the surrounding environment is the sensor data acquired by a surroundings monitoring unit 33 of the autonomous vehicle 30, and may include, for example, detection data of an object detected by a LIDAR and an image captured by a camera. Further, when the autonomous vehicle 30 has acquired data concerning the surroundings from infrastructure, other vehicles, networks, or the like via V2X communication, such data may also be used.

The determination unit 12 uses conditions for assistance (assistance conditions) stored in the applicable condition storage unit 13 to determine whether to notify an operator of a request for assistance (assistance request). Hereinafter, the assistance conditions stored in the applicable condition storage unit 13 will be described.

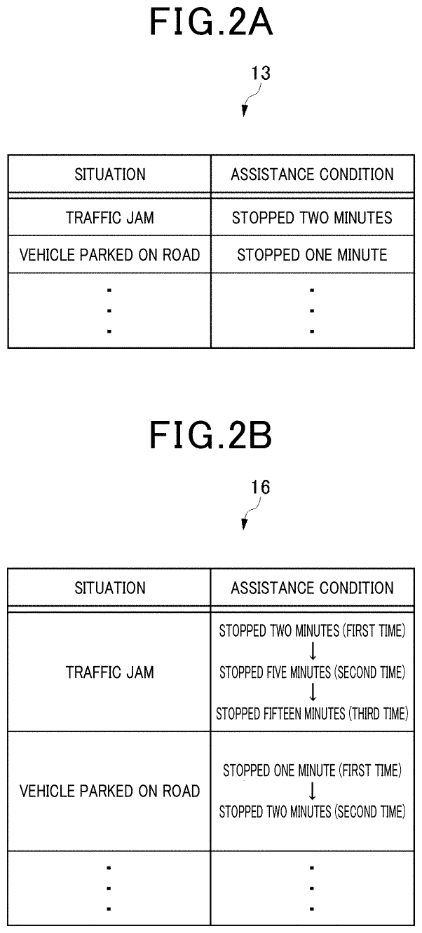

FIG. 2A is a diagram illustrating an example of assistance conditions stored in the applicable condition storage unit 13. As illustrated in FIG. 2A, the applicable condition storage unit 13 stores assistance conditions associated with various situations. In the situation in which there is a traffic jam, the assistance condition is that an autonomous vehicle has been stopped for two minutes. In the situation in which a vehicle parked on a road is present, the assistance condition is that an autonomous vehicle has been stopped for one minute. The assistance conditions are different from each other depending on the number of assistance requests while the same situation continues. The condition table 16 stores respective assistance conditions applied when assistance is provided a plurality of times under the same situation.

FIG. 2B is a diagram illustrating an example of data stored in the condition table 16. As illustrated in FIG. 2B, the condition table 16 stores assistance conditions, which are associated with situations, at respective times. In the situation in which there is a traffic jam, the assistance condition for a first time is that an autonomous vehicle has been stopped for two minutes, the assistance condition for a second time is that an autonomous vehicle has been stopped for five minutes, and the assistance condition for a third time is that an autonomous vehicle has been stopped for fifteen minutes. Thus, the assistance conditions stored in the condition table 16 are set so that frequency of notification to an operator decreases as the number of times of assistances increases. Specifically, the duration period (minute) during which a vehicle is stopped (vehicle stop duration) in the assistance conditions can be determined based on, as an example, data concerning a time period during which the vehicle is stopped (stop period) in the past. For example, in a distribution of the past stop period, a stop period deviated longer from an average value of stop periods by a standard deviation σ may be set as an assistance condition for a first time, and a stop period deviated longer from the average value of stop periods by 2σ may be set as an assistance condition for a second time.

The applicable condition storage unit 13 stores assistance conditions to be applied in determinations read from the condition table 16, according to the number of times of assistances. The number of times of assistances is the number of times of requests to an operator for assistance, and is counted as one even when the operator determines that assistance is unnecessary as a result of the request for assistance. The process for determining an applicable condition based on the condition table 16 is performed by the condition update unit 15.

The condition update unit 15 updates conditions to be used stored in the condition table 16 depending on the number of times assistance is provided by an operator in the situation in which the autonomous vehicle is placed. When assistance has been provided by the operator, the condition update unit 15 updates a condition to be used included in a plurality of conditions stored in the condition table 16. When the situation is changed, the condition update unit 15 initializes the condition, that is, restores the condition to the condition for requesting assistance for a first time. For example, a case is assumed where an assistance request is issued in a situation in which there is a traffic jam, and then the next applicable condition is updated to a condition that the vehicle stop duration is five minutes. If thereafter the situation is changed because the traffic jam finishes, the applicable condition is restored to a condition that the vehicle stop duration is two minutes.

The determination unit 12 will be described. The determination unit 12 determines a situation in which an autonomous vehicle is placed based on the data included in a vehicle state, and determines whether the situation satisfies the condition for requesting assistance from an operator. When the determination unit 12 has received data concerning the surrounding environment, the determination unit 12 may use the data concerning the surrounding environment to determine the situation in which the autonomous vehicle is placed.

The situation in which the autonomous vehicle is placed is, for example, a traffic jam. Whether the autonomous vehicle is caught in a traffic jam can be determined from data on a speed of the vehicle. That is, when the vehicle repeats a stop and a start at a certain speed or less, it can be determined a traffic jam has occurred.

The situation storage unit 14 has a function of storing data on a situation for each autonomous vehicle for a certain period of time. Referring to the data on situations stored in the situation storage unit 14 can determine whether the situation in which an autonomous vehicle is placed has changed.

If the determination unit 12 determines that the assistance condition is satisfied, the determination unit 12 notifies the operator cooperation unit 17 that the assistance condition is satisfied. On receiving the notification, the operator cooperation unit 17 sends a notification of requesting assistance for the autonomous vehicles 30, to the operator terminal 40. At this time, the operator cooperation unit 17 transmits data concerning the corresponding autonomous vehicle 30 to the operator terminal 40.

### [Autonomous Vehicle]

The autonomous vehicle 30 includes a traveling control unit 31, a passenger compartment monitoring unit 32, the surroundings monitoring unit 33 and a communication unit 34. The traveling control unit 31 has a function of controlling traveling of the autonomous vehicle 30. The traveling control unit 31 controls throttle, braking, steering, and the like. The passenger compartment monitoring unit 32 has a function of monitoring the state of a driver and occupants. The passenger compartment monitoring unit 32 may be, for example, a camera capturing images inside a passenger compartment, or a seating sensor. The surroundings monitoring unit 33 has a function of monitoring the surroundings of the vehicle. The surroundings monitoring unit 33 may include, for example, a camera, a LIDAR device, a millimeter-wave radar device, an ultrasonic sensor, and the like. The communication unit 34 has a function of communicating with the monitoring center 10. The communication unit 34 includes a communication device, an antenna, and the like. In addition, the communication unit 34 may further have a function of communicating with infrastructure or other vehicles.

### [Operation of Monitoring Center]

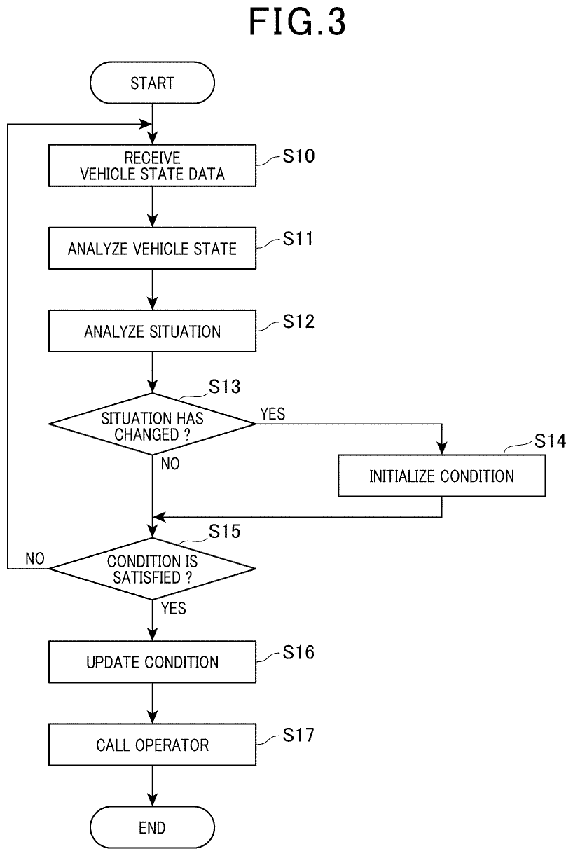

FIG. 3 is a flowchart showing operation of the monitoring center 10. The monitoring center 10 receives vehicle state data from the autonomous vehicle 30. The determination unit 12 of the monitoring center 10 analyzes a vehicle state based on the vehicle state data to determine a vehicle stop duration of the vehicle. In the present embodiment, although a vehicle stop duration is determined because the assistance condition concerns a stop period, the vehicle state to be determined may be appropriately changed depending on the assistance condition.

The determination unit 12 determines a situation in which the autonomous vehicle 30 is placed. The condition update unit 15 determines whether the situation in which the autonomous vehicle 30 is placed has changed. If it is determined that the situation has changed from when an assistance request was issued last time, the condition update unit 15 initializes a condition (applicable condition) used for determining whether assistance by an operator is necessary.

Next, the determination unit 12 reads an assistance condition corresponding to a current situation from the applicable condition storage unit 13 and compares the read assistance condition with a vehicle stop duration of the vehicle to determine whether the vehicle stop duration satisfies the assistance condition. For example, it is supposed that the situation in which the autonomous vehicle 30 is placed is a traffic jam. Since the assistance condition, illustrated in FIG. 2A, stored in the applicable condition storage unit 13 is that a top state has continued for two minutes, the determination unit 12 determines whether the top state has continued for two minutes. If it is determined that the condition is not satisfied, the monitoring center 10 returns to the process for receiving data on the vehicle state from the autonomous vehicle.

If the determination unit 12 determines that the condition for assistance by an operator is satisfied, the condition update unit 15 updates the condition for assistance by an operator in a traffic jam state according to the data stored in the condition table 16. That is, the condition update unit 15 reads an assistance condition for a second time from the condition table 16 and stores the read assistance condition in the applicable condition storage unit 13. The operator cooperation unit 17 of the monitoring center 10 transmits a notification of an assistance request to the operator terminals 40, to call an operator.

In FIG. 3, operation is illustrated which starts with communication with one autonomous vehicle 30 as a trigger. However, the monitoring center 10 monitors a plurality of autonomous vehicles 30 and simultaneously performs the process illustrated in FIG. 3 for the plurality of autonomous vehicles 30.

The configuration of the monitoring center 10 of the present embodiment has been described. An example of hardware of the monitoring center 10 is a computer including a CPU, a RAM, a ROM, a hard disk, a display, a keyboard, a mouse, and a communication interface. The monitoring center 10 is implemented by storing a program having modules for implementing the functions described above in the RAM or the ROM and executing the program by the CPU. Such a program is also included in the scope of the present disclosure.

The monitoring system of the first embodiment updates the condition for requesting assistance after assistance is requested to an operator. Hence, the operator is not called under the same condition as that at the last time, thereby reducing load of the operator. Specifically, in a state of a traffic jam, continuously watching an autonomous vehicle in the traffic jam is inefficient, and support of the operator is not required. When the traffic jam continues, prolonging the time period for transmitting an assistance request can decrease the number of calls to an operator. In another example, an operator determines not to provide assistance because of a traffic jam. However, if the determination by the operator is incorrect, and an autonomous vehicle continues to stop due to another reason, the operator is called again under the condition different from that at the last time. Hence, the problem can be prevented from being not overcome. In addition, an operator provides assistance by determining a situation by viewing real-time images. However, even in a situation in which the determination by the operator is different from in-car determination of the autonomous vehicle due to an oversight by the operator or the like, and the autonomous vehicle cannot start in accordance with the assistance, the operator is called again under another condition while the autonomous vehicle continues to stop. Hence, the problem can be prevented from being not overcome.

### Second Embodiment

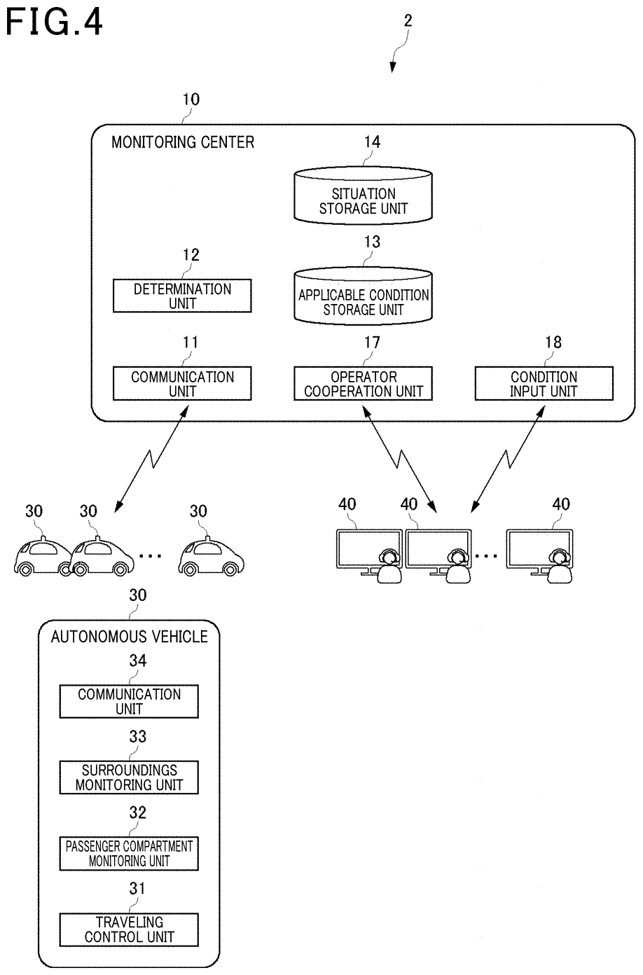

FIG. 4 is a diagram illustrating a configuration of a monitoring system 2 of the second embodiment. The basic configuration of the monitoring system 2 of the second embodiment is the same as that of the monitoring system 1 of the first embodiment. However, the configuration of the monitoring system 2 of the second embodiment is different from that of the monitoring system 1 of the first embodiment in that the monitoring system 2 receives the condition for calling an operator at a second time or later through the operator terminals 40.

The monitoring center 10 includes a condition input unit 18 that receives input of conditions from an operator in place of the condition update unit 15 of the first embodiment. The monitoring center 10 updates the condition for calling an operator at a second time or later under the condition received by the condition input unit 18.

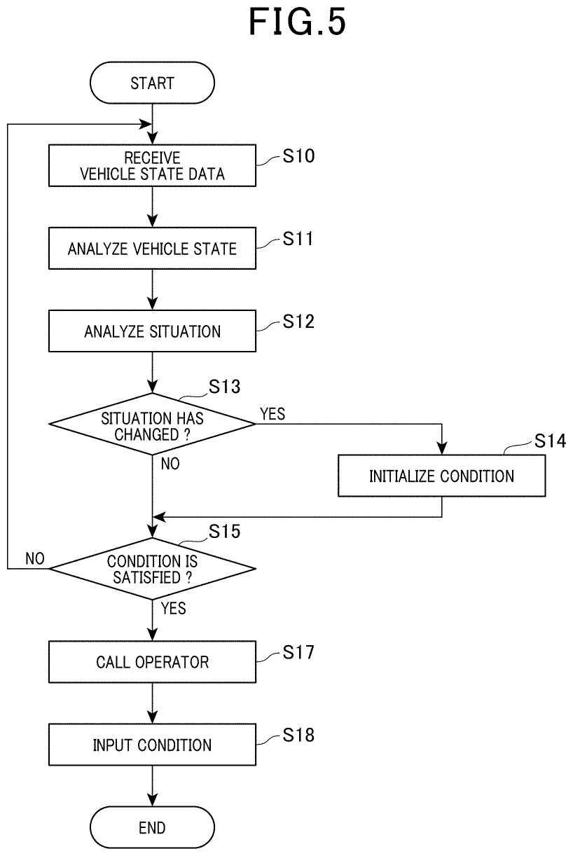

FIG. 5 is a flowchart illustrating operation of the monitoring center 10 of the second embodiment. The basic operation of the monitoring center 10 of the second embodiment is the same as that of the monitoring center 10 of the first embodiment. However, if it is determined that the condition for calling an operator is satisfied, the monitoring center 10 of the second embodiment calls an operator, without updating the next condition for calling an operator, to receive input of a condition from the operator.

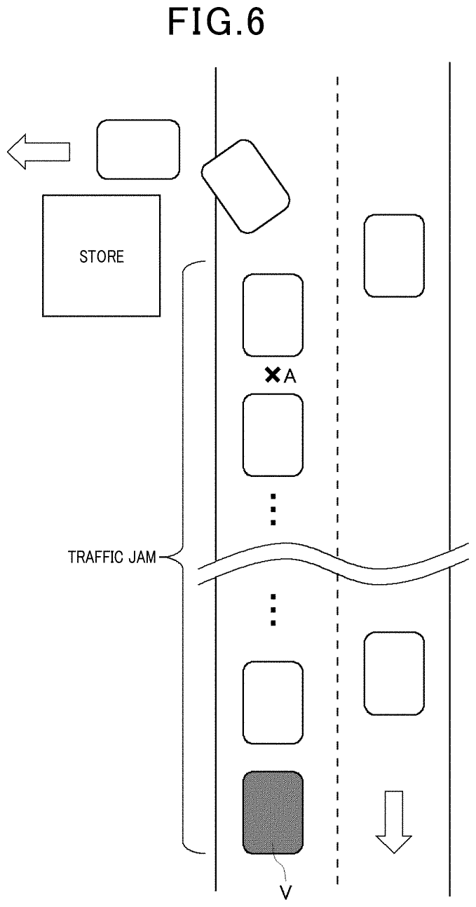

FIG. 6 is a diagram for describing an example of an assistance condition input by an operator. FIG. 6 shows a situation in which a traffic jam has occurred due to vehicles queueing to enter a store. A target autonomous vehicle V is present at the rear of the traffic jam. In this state, if the autonomous vehicle V continuously stops for two minutes, assistance is requested from an operator. Since the operator can see that there is a traffic jam from images or data on a vehicle state transmitted from the autonomous vehicle V, the operator determines that assistance is not necessary. Then, the operator inputs, as a condition for assistance for a second time, a condition that the autonomous vehicle V has reached a point A in the vicinity of the store. If the autonomous vehicle V reaches the point A, the autonomous vehicle V can pass the vehicle in front of the autonomous vehicle V because there is no traffic jam after the point A, whereby the operator can provide assistance appropriately.

A traffic jam due to vehicles queueing to enter a store has been described above as an example. However, other examples of a point to be set as a condition can be considered as, for example, a point where a road having one lane, in which the autonomous vehicle 30 is traveling and passing is prohibited, changes to a road having two lanes. In addition, assistance conditions have been set depending on a point the vehicle has reached. However, also when an operator sets a condition, the condition for assistance can also be set depending on a vehicle stop duration.

As in the first embodiment, the monitoring system 2 of the second embodiment can change the condition for requesting assistance after assistance is requested from an operator. At this time, since the operator inputs a condition, an appropriate condition can be set depending on a situation in which the autonomous vehicle 30 is placed.

### Third Embodiment

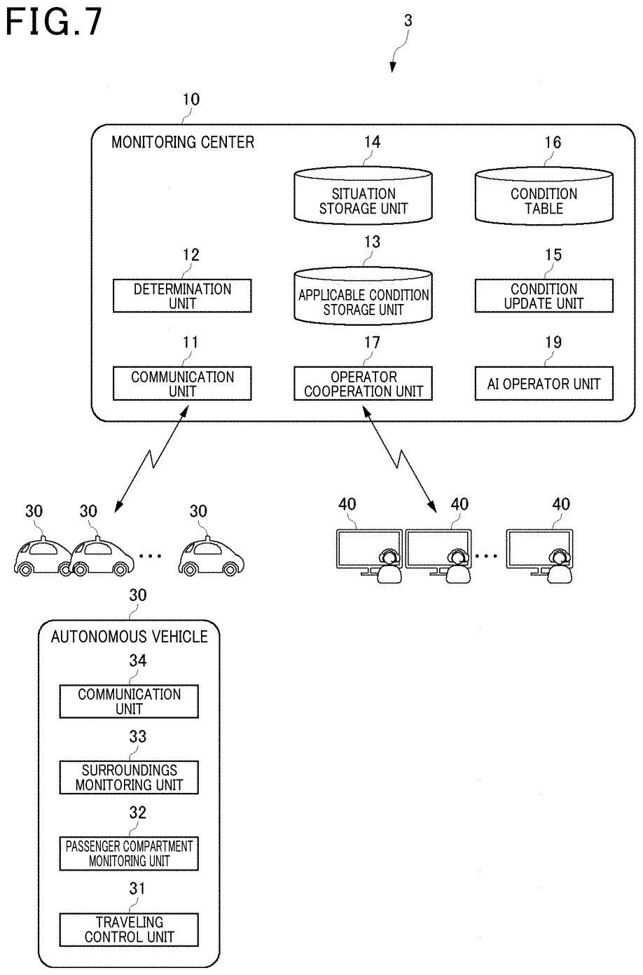

FIG. 7 is a diagram illustrating a configuration of a monitoring system 3 of the third embodiment. The basic configuration of the monitoring system 3 of the third embodiment is the same as that of the monitoring system 1 of the first embodiment. However, the configuration of the monitoring system 3 of the third embodiment is different from that of the monitoring system 1 of the first embodiment in that an AI operator unit 19 is further included.

The AI operator unit 19 has a function of using artificial intelligence techniques to analyze vehicle state data transmitted from the autonomous vehicle 30 and surrounding environment data, to assist the autonomous vehicle 30. An example of the technique for implementing the AI operator unit 19 is a neural network. That is, learning of a neural network model may be performed using examples of operator's assistance as teaching data. Then, contents of assistance may be determined from images transmitted from the autonomous vehicle 30 by using the learned model.

When the condition for assistance by an operator is satisfied a first time, the monitoring center 10 does not immediately establish connection to a human operator but provides assistance by the AI operator unit 19. At this time, as in the first embodiment, the condition for requesting assistance at a second time is updated.

Subsequently, when the condition for requesting assistance at the second time or later is satisfied, the operator cooperation unit 17 notifies the operator terminal 40 of an assistance request. Hence, the AI operator unit 19 performs a process for the assistance request the first time. If thereby certain assistance is completed, load on a human operator can be reduced.

Embodiments of a monitoring system of the present disclosure have been described in detail. However, the monitoring system of the present disclosure is not limited to the embodiments described above.

In the above embodiment, an example has been described in which a condition for assistance by an operator is set for each situation. However, the conditions for assistance may be the same regardless of situations. For example, even when a traffic has occurred or a vehicle parked on a road is present, the condition for assistance may be set to vehicle stop durations of two minutes a first time, five minutes a second time, and fifteen minutes a third time. However, even when the same assistance condition is set as describe above, the situation in which the autonomous vehicle 30 is placed is required to be grasped in order to update and initialize the condition by the condition update unit 15.

In the above embodiment, an example has been described in which the monitoring center 10 analyzes vehicle state data and surrounding environment data to determine whether an assistance condition is satisfied. However, these functions may be performed by the autonomous vehicle 30. That is, in the monitoring system, the functions for, for example, analyzing and determining data may be arbitrarily divided.

In the above embodiment, an example has been described in which the situation is a traffic jam. In a case of a traffic jam, the assistance condition is gradually prolonged in such a manner as two minutes five minutes fifteen minutes. However, when the monitoring center 10 has found a section, in which there is a traffic jam, based on information from a vehicle information and communication system (VICS (registered trademark)) or other vehicles, the assistance condition may be changed from the beginning for the autonomous vehicle present in the section. For example, the assistance condition at a first time may be a vehicle stop duration of fifteen minutes to decrease the number of notifications to an operator.

The monitoring center 10 of the present embodiment stores, in the situation storage unit 14, a situation of the autonomous vehicles 30 when an assistance request is issued to the situation storage unit 14 last time. Hence, this information may be provided to the operator terminal 40 as succeeded information. For example, the operator cooperation unit 17 may cause the operator terminal 40 to display, as an assistance history, information on, for example, the date and time at which an assistance request is accepted last time, contents of assistance, and the reason why the determination is made.

The monitoring system according to the present disclosure is useful for a system monitoring autonomous vehicles.

An aspect of the present disclosure provides a monitoring center (10) that communicates with an autonomous vehicle (30) via a network to monitor the autonomous vehicle. The monitoring center includes: a communication unit (11) that receives data regarding a vehicle state from the autonomous vehicle; a determination unit (12) determines whether a state of the autonomous vehicle satisfies a condition for assistance by an operator based on the data regarding a vehicle state; and an operator cooperation unit (17) that notifies the operator of an assistance request if it is determined that the condition is satisfied. The determination unit performs the determination based on a condition different from the last condition if a situation in which the autonomous vehicle is placed is not changed from when an assistance request is issued last time.

According to the monitoring center of the present disclosure, if a situation in which the autonomous vehicle is placed is not changed, it is determined whether assistance is necessary based on a condition different from the last condition. Hence, an operator is not called under the same condition as that at the last time, thereby reducing load of the operator.

What is claimed is:

1. A monitoring center that communicates with an autonomous vehicle via a network to monitor the autonomous vehicle, the monitoring center comprising:
a communication unit that receives data regarding a vehicle state from the autonomous vehicle;
a determination unit determines whether a state of the autonomous vehicle satisfies a condition for assistance by an operator based on the data regarding a vehicle state; and
an operator cooperation unit that notifies the operator of an assistance request if it is determined that the condition is satisfied, wherein
the determination unit performs the determination based on a condition different from the last condition if a situation in which the autonomous vehicle is placed is not changed from when an assistance request is issued last time.

2. The monitoring center according to claim 1 further comprising:
a condition table that stores respective associated conditions for assistance applied when assistance is provided a plurality of times; and
a condition update unit that uses the condition table to update the condition for assistance when the operator is notified and initializes the condition for assistance when it is determined that the situation in which the autonomous vehicle is placed is changed.

3. The monitoring center according to claim 2, wherein
the conditions for assistance stored in the condition table are set so that frequency of notification to the operator decreases as the number of times of assistances increases.

4. The monitoring center according to claim 1, further comprising a condition input unit that receives input of a next condition for assistance from the operator, wherein
the condition is updated based on the condition received by the condition input unit.

5. The monitoring center according to claim 4, wherein
when a situation in which the autonomous vehicle is placed is a traffic jam, the condition input unit receives, as the condition for assistance, an input concerning a point at which the traffic jam is cancelled.

6. The monitoring center according to claim 1, further comprising an AI operator unit that assists the autonomous vehicle by artificial intelligence based on the data regarding a vehicle state, wherein
if the determination unit determines that the condition for assistance is satisfied, the AI operator unit performs the assistance a first time, and the operator cooperation unit notifies the operator at a second time or later.

7. A monitoring system that includes an autonomous vehicle and a monitoring center that is connected to the autonomous vehicle via a network to monitor the autonomous vehicle, the monitoring center comprising:
a determination unit that determines whether a state of the autonomous vehicle satisfies a condition for assistance by an operator, based on data regarding a vehicle state of the autonomous vehicle; and
an operator cooperation unit that notifies the operator of an assistance request if it is determines that the condition is satisfied, wherein
the determination unit performs the determination based on a condition different from the last condition if a situation in which the autonomous vehicle is placed is not changed from when an assistance request is issued last time.

8. The monitoring system according to claim 7 further comprising:
a condition table that stores respective associated conditions for assistance applied when assistance is provided a plurality of times; and
a condition update unit that uses the condition table to update the condition for assistance when the operator is notified and initializes the condition for assistance when it is determined that the situation in which the autonomous vehicle is placed is changed.

9. The monitoring system according to claim 8, wherein
the conditions for assistance stored in the condition table are set so that frequency of notification to the operator decreases as the number of times of assistances increases.

10. The monitoring system according to claim 7, further comprising a condition input unit that receives input of a next condition for assistance from the operator, wherein
the condition is updated based on the condition received by the condition input unit.

11. The monitoring system according to claim 10, wherein
when a situation in which the autonomous vehicle is placed is a traffic jam, the condition input unit receives, as the condition for assistance, an input concerning a point at which the traffic jam is cancelled.

12. The monitoring system according to claim 7, further comprising an AI operator unit that assists the autonomous vehicle by artificial intelligence based on the data regarding a vehicle state, wherein
if the determination unit determines that the condition for assistance is satisfied, the AI operator unit performs the assistance a first time, and the operator cooperation unit notifies the operator at a second time or later.

13. A method performed by a monitoring center that monitors an autonomous vehicle for cooperating with an operator that provides assistance to the autonomous vehicle, the method comprising the steps of:
receiving data regarding a vehicle state from the autonomous vehicle;
determining whether a state of the autonomous vehicle satisfies a condition for assistance by the operator, based on the data regarding a vehicle state, the determination being performed based on a condition different from the last condition if a situation in which the autonomous vehicle is placed is not changed from when an assistance request is issued last time, and
notifying the operator of an assistance request if it is determined that the condition is satisfied.
